(19) United States
(12) Patent Application Publication
(10) Pub. No.: US 2008/0038945 A1
(43) Pub. Date: Feb. 14, 2008

(54) Printed circuit board

(75) Inventor: Yoshihiro Kawamura, Shizuoka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: YAZAKI CORPORATION

(21) Appl. No.: 11/819,105

(22) Filed: Jun. 25, 2007

(30) Foreign Application Priority Data
Aug. 8, 2006 (JP) 2006-215664

(51) Int. Cl. H01R 12/00

(52) U.S. Cl. 439/85; 174/260

(57) ABSTRACT

A film capacitor 13 for filtering mounted on a substrate is higher than a projected lead wire of the high voltage terminal. The lead wire of the high voltage terminal is interposed between the film capacitor and a connector housing. A gap is so formed between the film capacitor and the connector housing as to prevent a finger from entering the gap.

### CROSS REFERENCE TO RELATED APPLICATIONS

This application is on the basis of Japanese Patent Application No. 2006-215664, the contents of which are hereby incorporated by reference.

### BACKGROUND OF THE INVENTION

1. Field of the Invention

The present invention relates to a printed circuit board, and in particular, the printed circuit board having a connector housing mounted on the printed circuit board, positive and negative terminals respectively connected to positive and negative terminals of a battery, and lead wires of the terminals extending from the printed circuit board to the connector.

2. Description of the Related Art

In recent years, a hybrid vehicle (HEV) having an electric motor as a driving force, a fuel cell electric vehicle (FCEV), an electric vehicle (EV) have been spread. Each of these electric vehicles includes two types of batteries: a low voltage battery about 12 volts for starting an engine, and a high voltage battery for driving the electric motor.

A conventional printed circuit board mounted on such an EV is shown in FIGS. 3 to 5. As shown in figures, the printed circuit board includes a substrate 10, a connector housing 11 mounted on the substrate 10, and terminal fittings 12 received in terminal insertion holes formed on the connector housing 11. The terminal fittings 12 include a high voltage positive terminal T+ and a high voltage negative terminal T− connected to positive and negative terminals of the high voltage battery. The terminal fittings 12 also include low voltage terminals T1 to T5 connected to the low voltage battery.

One ends of lead wires of the high voltage terminals T+, T− are projected from the terminal insertion holes formed on an upper row of a sidewall of the connector housing 11. The other ends of the lead wires of the high voltage terminals T+, T− are connected to terminals mounted on the substrate 10. One ends of lead wires of the low voltage terminals T1 to T5 are projected from the terminal insertion holes formed on a lower row of the sidewall of the connector housing 11. The other ends of the lead wires of the low voltage terminals T1 to T5 are connected to terminals mounted on the substrate 10. In the connector housing 11, the low voltage terminals T1 to T5 are interposed between the high voltage terminals T+, T−.

Because the high voltage terminals T+, T− are received in the upper row of the terminal insertion holes of the connector housing 11, a worker easily touches the lead wires of the high voltage terminals T+, T−. Therefore, there is a problem that a worker may unintentionally touch the lead wires of the high voltage terminals T+, T− at the same time to get an electric shock. Therefore, as shown in FIG. 6, the low voltage terminals may be received in the upper row, and the high voltage terminals may be received in the lower row. However, because the number of the terminal insertion holes at the upper row is smaller than that at the lower row, an isolation distance L1 between the high voltage terminals T+, T− and the low voltage terminals T1 to T5 in FIG. 6 is shorter than an isolation distance L2 in FIG. 4.

The lead wires of the high voltage terminals T+, T− may be coated with insulating material. However, secure isolation is difficult due to uneven coating. Further, it takes cost to coat the lead wires. Further, because typical insulating material includes volatile material and environmental load, using the insulating material is not preferable considering an effect on the environment.

Accordingly, an object of the present invention is to provide a low cost printed circuit board able to prevent a worker from getting an electric shock.

### SUMMARY OF THE INVENTION

In order to attain the object, according to the present invention, there is provided a printed circuit board including:

a substrate;

a connector housing mounted on the substrate;

positive and negative terminals having lead wires of which one ends are projected from a sidewall of the connector housing and the other ends are connected to the substrate; and

an insulating member mounted on the substrate,

wherein the insulating member is higher than at least one of the projected lead wires of the positive and negative terminals,

wherein the one of the projected lead wires is interposed between the insulating member and the connector housing, and

wherein a gap between the insulating member and the connector housing is so formed as to prevent a finger from entering the gap.

Preferably, the insulating member is a surface-mounted component mounted on the substrate.

Preferably, the insulating member is a filtering capacitor.

These and other objects, features, and advantages of the present invention will become more apparent upon reading of the following detailed description along with the accompanied drawings.

### BRIEF DESCRIPTION OF THE DRAWINGS

FIG. 1 is a top view showing an embodiment of a printed circuit board according to the present invention;

FIG. 2 is a side view showing the printed circuit board of FIG. 1;

FIG. 3 is a top view showing a conventional printed circuit board;

FIG. 4 is a partially sectional view taken on line I-I of FIG. 3;

FIG. 5 is a side view showing the printed circuit board in FIG. 3; and

FIG. 6 is a partially sectional view showing a connector housing of another conventional printed circuit board.

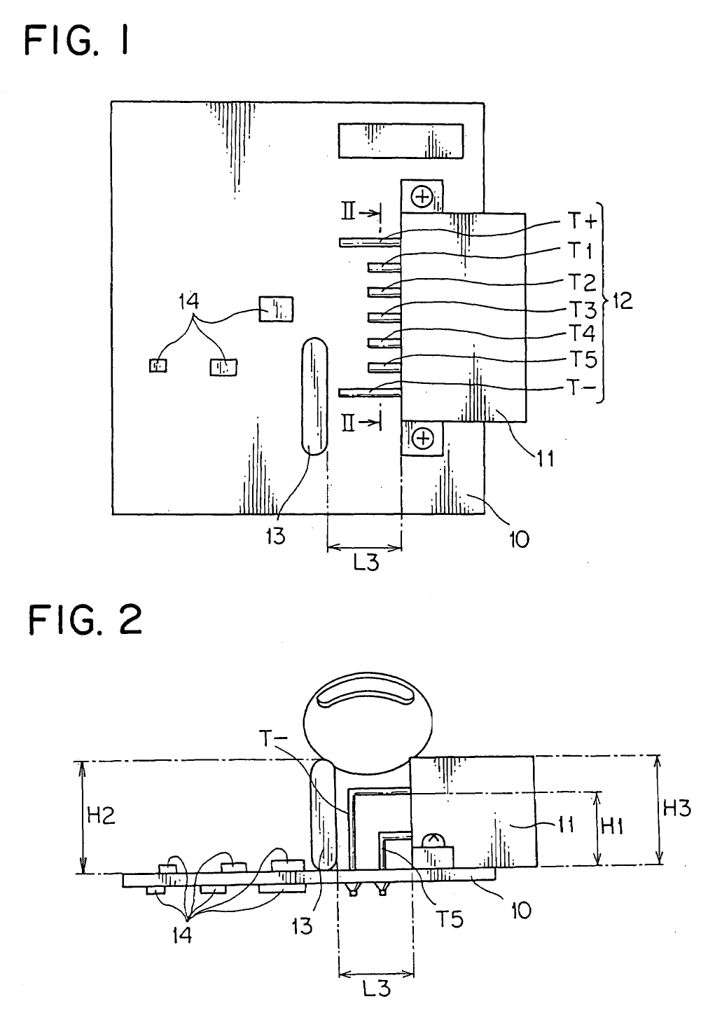

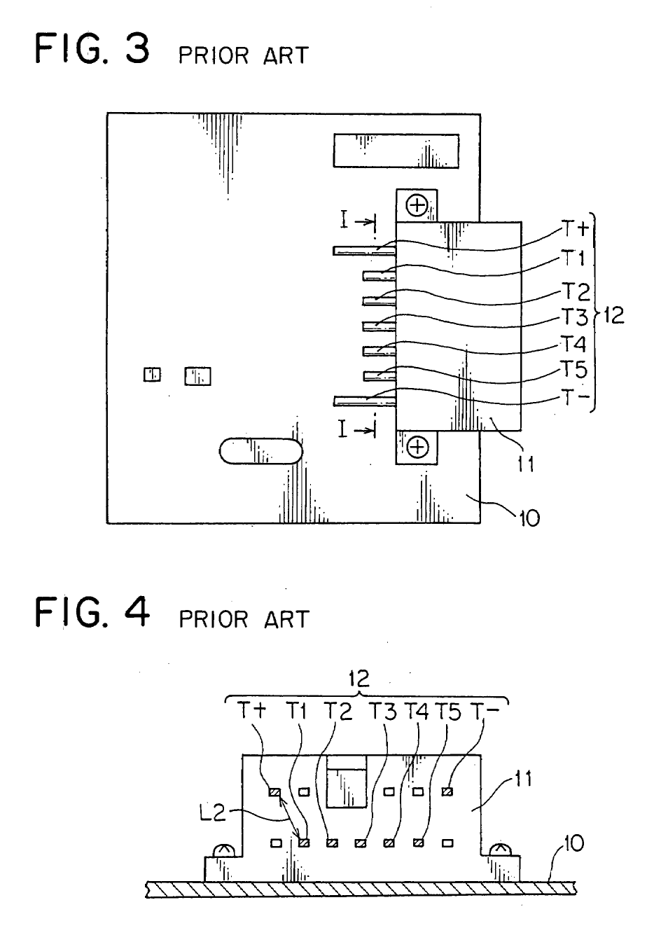

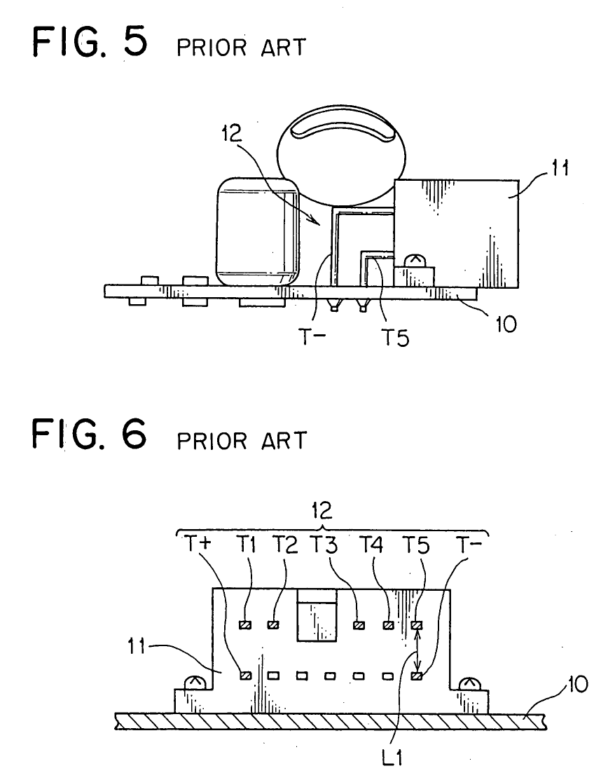

### DETAILED DESCRIPTION OF THE PREFERRED EMBODIMENTS

An embodiment of a printed circuit board according to the present invention will be explained with figures. As shown in FIG. 1, the printed circuit board includes a substrate 10, a connector housing 11 mounted on the substrate 10, and terminal fittings 12 received in terminal insertion holes formed on the connector housing 11.

The terminal fittings 12 include a high voltage positive terminal T+, and a high voltage negative terminal T− respectively connected to positive and negative terminals of a high voltage battery. The terminal fittings 12 also include low voltage terminals T1 to T5 connected to a low voltage battery.

As shown in FIG. 4, one ends of lead wires of the high voltage terminals T+, T− are projected from terminal insertion holes formed on an upper row of a sidewall of the connector housing 11. The other ends of the lead wires of the high voltage terminals T+, T− are connected to terminals on the substrate 10. One ends of lead wires of the low voltage terminals T1 to T5 are projected from terminal insertion holes formed on a lower row of the sidewall of the connector housing 11. The other ends of the lead wires of the low voltage terminals T1 to T5 are connected to terminals on the substrate 10. The low voltage terminals T1 to T5 are interposed between the high voltage terminals T+, T−. In this embodiment, projection heights H1 of the high voltage terminals T+, T− are the same.

Further, a film capacitor 13 for noise filtering and a plurality of surface-mounted components 14 are mounted on the substrate 10. A body of the film capacitor 13 (insulating member) is coated with insulating resin. A height H2 of the film capacitor 13 is higher than the projection height H1 of the high voltage terminals T+, T−. A height H3 of the connector housing 11 is naturally higher than the projection height H1 of the high voltage terminals T+, T−.

On the substrate 10, the projected lead wire of the high voltage terminal T− is interposed between the film capacitor 13 and the connector housing 11. A gap between the film capacitor 13 and the connector housing 11 are so narrow as to prevent a finger from entering the gap. Namely, a length L3 between the film capacitor 13 and the connector housing 11 is smaller than a finger of a worker, for example, less than one centimeter.

According to the printed circuit board described above, a finger cannot touch the lead wire of the high voltage terminal T− interposed between the film capacitor 13 and the connector housing 11. Therefore, a finger cannot tough both the high voltage terminals T+, T− at the same time, and a worker is prevented from getting an electric shock at low cost. Further, because the film capacitor 13 coated with the insulating resin is disposed near the high voltage terminal T−, isolation between the high voltage terminal T− and the other surface-mounted components 14 is secured.

According to the printed circuit board described above, the film capacitor 13 is also used as the insulating member to reduce a cost of the printed circuit board.

According to the printed circuit board described above, the film capacitor 13 is disposed near the high voltage terminal T−. Therefore, a wiring pattern is advantageous, and because a small loop near the terminal T− forms a filtering circuit, an effect of the filtering is improved.

Both a small ceramic capacitor and a large film capacitor can be used as a filtering capacitor. According to this embodiment, a large size of the film capacitor is used for preventing a worker from getting an electric shock.

Incidentally, according to the above embodiment, the film capacitor 13 is used as the insulating member. However, the present invention is not limited to this. Other surface-mounted components can be used as the insulating member as long as a height thereof is higher than the height H1. Further, the insulating member may not a surface-mounted component.

According to the above embodiment, the film capacitor 13 as the insulating member is mounted on the substrate 10. However, the present invention is not limited to this. For example, a rib formed on a case for receiving the printed circuit board may be the insulating member. This rib may be mounted on the substrate 10 by inserting the rib into a slit formed on the printed circuit board. In this case, when the rib is inserted into the slit, a height of the rib is higher than the height H1.

According to the above embodiment, the lead wire of the high voltage terminal T− is interposed between the film capacitor 13 and the connector housing 11. However, the present invention is not limited to this. For example, the lead wire of the high voltage terminal T+ may be interposed between the film capacitor 13 and the connector housing 11. Further, two of the insulating member may be mounted on the substrate 10 so that both the high voltage terminals T+, T− may be interposed between the insulating members and the connector housing 11.

According to the above embodiment, a gap is formed between the film capacitor 13 and the high voltage terminal T−. However, the present invention is not limited to this. The film capacitor 13 may touch the high voltage terminal T−. In this case, the film capacitor 13 and the high voltage terminal T− may be rubbed against each other due to a vibration. Therefore, preferably, the gap is formed between the film capacitor 13 and the high voltage terminal T−.

According to the above embodiment, the lead wires of the low voltage terminals are projected from the sidewall of the connector housing 11. However, the present invention is not limited to this. Only the lead wires of the high voltage terminals T+, T− may be projected from the sidewall of the connector housing 11.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A printed circuit board comprising:
a substrate;
a connector housing mounted on the substrate;
positive and negative terminals having lead wires of which one ends are projected from a sidewall of the connector housing, and the other ends are connected to the substrate; and
an insulating member mounted on the substrate,
wherein the insulating member is higher than at least one of the projected lead wires of the positive and negative terminals,
wherein the one of the projected lead wires is interposed between the insulating member and the connector housing, and
wherein a gap between the insulating member and the connector housing is so formed as to prevent a finger from entering the gap.

2. The printed circuit board as claimed in claim 1,
wherein the insulating member is a surface-mounted component mounted on the substrate.

3. The printed circuit board as claimed in claim 2,
wherein the insulating member is a filtering capacitor.
